(19) United States
(12) Patent Application Publication
(10) Pub. No.: US 2015/0290842 A1
(43) Pub. Date: Oct. 15, 2015

(54) MOLD, CONTROL MEANS, METHOD AND INSTALLATION FOR PRODUCING A PREFERABLY FIBER-REINFORCED PLASTIC COMPONENT

(71) Applicant: DIEFFENBACHER GMBH MASCHINENUND ANLAGENBAU, Eppingen (DE)

(72) Inventor: Matthias GRAF, Eppingen (DE)

(73) Assignee: Dieffenbacher GmbH Maschinen-und Anlagenbau, Eppingen (DE)

(21) Appl. No.: 14/438,516

(22) PCT Filed: Oct. 25, 2013
(86) PCT No.: PCT/EP2013/072372

§ 371 Date: Apr. 24, 2015

(30) Foreign Application Priority Data
Oct. 29, 2012 (DE) 10-2012 110 354.2

(51) Int. Cl. B29C 33/00; B29C 70/48

(52) U.S. Cl. CPC B29C 33/0038; B29C 70/48; B29K 2105/0809

(57) ABSTRACT

A molding tool, a control means, and a method for producing a preferably fiber-reinforced plastic component and a facility for performing the method. A molding tool according to the invention includes at least one first seal arranged according to plan between the first and the second tool part with respect to the opening to the vacuum connection such that in a first closed position of the tool parts, the cavity can be evacuated via the opening to the vacuum connection, and in a second closed position of the tool parts, the evacuated cavity is also sealed in relation to the opening to the vacuum connection. The present invention has the advantage that using the same seal, which seals the tool parts in relation to the ambient air pressure thereof, the cavity may both be evacuated via the opening to the vacuum connection and also the evacuated cavity may be sealed in relation to the opening to the vacuum connection as needed.

The present invention relates to molding tool, a control means, and a method for producing a preferably fiber-reinforced plastic component. The subject matter of the present invention is finally also a facility for carrying out the method.

The resin transfer molding method (RTM method) is known, inter alia, for the production of fiber-reinforced plastic components (fiber composite components) and in particular carbon fiber-reinforced plastic components (CFRP components). The production of a fiber composite component by means of this method is performed in industrial use in sequentially running individual processes.

In a first process step, the so-called preform process, the fiber semifinished products, which are generally provided as a multilayered fabric or scrim of fiber mats which are cut to size, are shaped, so that they already approximately have the geometry of the composite component to be manufactured. The individual fiber mats of the fiber semifinished products generally also have, in addition to the fiber mats themselves, a binder, which has adhesive-type properties. The binder causes pre-solidification of the individual fiber mats with one another and therefore of the pre-formed fiber preform (of the blank), so that they can be supplied in a dimensionally-stable manner to the following processes. The fiber preform can also only be called a preform.

For the preform process, pre-assembled fiber mats are thus generally laid one on top of another in layers to form a fiber semifinished product according to a predefined fiber layer structure. This fiber semifinished product, which is formed from fiber mats, is subsequently transferred into a preform tool at room temperature, or heated to a shaping temperature. The shaping of the fiber semifinished product into a fiber preform is performed by closing the tool. Finally, the edge region of the fiber preform thus created can also be trimmed (also referred to as trimming or net shaping hereafter), for example, by stamping or ultrasonic cutting, so that the fiber preform has defined contour edges. The fiber preform is subsequently demolded and optionally temporarily stored for carrying out the following process and method steps.

A first quality control can already take place during the temporary storage. By means of a visual check, in particular the molding burr of the fiber preform (of the blank) and possible fiber warping, fiber waviness, wrinkles, or similar superficial flaws can be recognized in this case.

In a following second process step, the RTM process, the fiber preform is laid in a cleaned and preferably release-coated, i.e., coated with an anti-adhesive agent, cavity of an RTM tool. The molding tool, which is typically in two parts, is subsequently closed by means of a press and a two-component resin system is injected into the cavity of the molding tool, wherein it penetrates the fiber structure of the fiber preform as a matrix material and encloses the fibers. After the curing of the resin system, the main form of the fiber-reinforced plastic component thus obtained can be demolded and optionally checked for quality again.

To keep the tool closed leak-tight during the injection of the resin, for the infiltration of the fiber preform, an elastomeric seal is typically located between the tool upper part and the tool lower part. Generally, commercially available round cord seals are used for this purpose. The fiber preform must also be very precise in its external contour in this case. This is usually achieved, as already described, by trimming the preform before the RTM process. In this case, however, it is still unavoidable that a gap exists between the blank and the seal. This gap has the negative property that a type of “channel” arises, usually in the edge region, through which the resin flows in in an uncontrolled manner and short-circuits the flow front inside the fiber preform. In this way, undesired air enclosures and incorrect impregnation can occur. In addition, the “channel” must also be filled with resin, which results in increased resin consumption and therefore in particular in competitive disadvantages in mass production.

To implement a fully automatic mass production process in the RTM method, the fact that the opening to a vacuum connection, which is arranged between tool upper part and tool lower part, for evacuating the cavity comes into contact with resin and must be cleaned in a time-consuming manner after the cycle is one of the significant handling requirements, in particular for resin which is injected under high pressure or over-compacted.

High cavity pressures of, for example, 35 to 100 bar or more are intrinsic to current so-called high-pressure RTM methods (HP-RTM), however, which concentrate on the production of fiber-reinforced plastic components in particular, such as high-performance fiber composite materials, by means of the most rapid possible resin injection with complete impregnation of the textile fiber reinforcement structures by the use of highly reactive resin systems. A drastic reduction of the heretofore typical cycle times results therefrom. A high-pressure RTM facility is used for the homogeneous mixing of highly reactive resin components and curing agent components. A differentiation is made in this case between high high-pressure compression RTM methods (HP-CRTM) and high-pressure injection RTM methods (HP-IRTM).

In the HP-CRTM process, the resin is injected into a molding tool, which is (slightly) opened in a defined manner and contains a fiber preform. After the injection operation, the molding tool is closed and the fiber preform is both compacted (over-compacted) and also simultaneously impregnated because of the high tool internal pressure of up to 100 bar, which results from the closing forces of the hydraulic press.

In the HP-IRTM method, the fiber preform, which is already located in a completely closed molding tool, is impregnated by a significant high resin injection pressure of, for example, 35 bar. The high injection pressure results in a time shortening of the impregnation phase.

Both HP-RTM methods have the advantages of:
short injection and impregnation times in the HP-CRTM and HP-IRTM methods;
short cycle times due to the use of highly reactive resin systems;
economically and ecologically efficient processing process, since comparatively very low resin excesses are used;
providing an optimized resin-fiber ratio in the plastic molded part, in particular for light construction.

The present invention is based on the object of providing a sealing method, which is improved in relation to the prior art, in particular is simplified and cost-effective, in particular for the opening to a vacuum connection for evacuating the cavity, which, using the advantages of the RTM method and in particular the high-pressure RTM method (HP-RTM), is equally economical and also suitable for automated mass production processes.

This object is achieved by a molding tool for producing a preferably fiber-reinforced plastic component having the features of Patent claim 1, by a control means for moving two tool parts of a molding tool toward one another having the features of Patent claim 7, by a method for producing a preferably fiber-reinforced plastic component having the features of Patent claim 11, and by a facility for performing a method for producing a preferably fiber-reinforced plastic component having the features of Patent claim 14, Advantageous implementations and refinements, which can be used individually or in combination with one another, are the subject matter of the dependent claims.

A molding tool according to the invention for producing a preferably fiber-reinforced plastic component proceeds from molding tools forming the species having at least two tool parts, which are movable toward one another into at least one first and one second closed position, using which a cavity can be formed, which corresponds to the desired component thickness of the plastic component to be manufactured; having at least one opening, which is implemented in one tool part, to a vacuum connection for evacuating the cavity; and having at least one seal which seals the tool parts in relation to the ambient air pressure thereof. A molding tool according to the invention is distinguished in relation to molding tools forming the species in that the at least one first seal between the first and the second tool parts is arranged in such a manner as planned in relation to the opening to the vacuum connection such that in a first closed position of the tool parts, the cavity can be evacuated via the opening to the vacuum connection and in a second closed position of the tool parts, the evacuated cavity is also sealed in relation to the opening to the vacuum connection. A molding tool implemented according to the invention has the advantage that using the same seal, which seals the tool parts in relation to the ambient air pressure thereof, the cavity may both be evacuated via the opening to the vacuum connection and also the evacuated cavity may be sealed in relation to the opening to the vacuum connection as needed.

In a first embodiment as planned of the molding tool, implementing the at least one first seal on one tool part and the opening to the vacuum connection in the other tool part has proven itself.

In a second, alternative or additional embodiment as planned of the molding tool, implementing the opening to the vacuum connection in a side wall of a tool part outside a region of the cavity which defines the component thickness of the plastic component has proven itself.

At least one tool part is preferably operationally connected to an injection facility in a manner, which is known per se, for introducing a resin system into the evacuated cavity. In particular an embodiment of the molding tool, in which the injection facility for introducing the resin system is operationally connected to the tool part in which the opening to the vacuum connection is also implemented, has proven itself in this case.

Finally, an embodiment is preferred according to the invention of the molding tool, in which, between the first and the second tool part, in addition at least one second seal, which seals the tool parts in relation to the ambient air pressure thereof, is arranged as planned in such a manner in relation to the first seal and the opening to the vacuum connection, that vacuum can advantageously also still be maintained in the tool via the opening when the tool parts have already been moved into the second closed position for an introduction of the resin system into the evacuated cavity.

The subject matter of the present invention is also a control means for moving two tool parts of a molding tool toward one another, in particular a molding tool as described above, wherein a cavity can be formed using the tool parts, which corresponds to the desired component thickness of the preferably fiber-reinforced plastic component to be manufactured, and wherein an ability to move the tool parts into at least two closed positions is enabled by means of the control means. A control means according to the invention is distinguished in relation to control means forming the species by a first closed position, in which at least one first seal seals the tool parts to one another in relation to the ambient air pressure thereof such that the cavity can be evacuated via an opening to a vacuum connection; and by a second closed position, in which the at least one first seal also seals the evacuated cavity in relation to the opening to the vacuum connection. Due to the advantageous ability to move the tool parts into at least two closed positions, using the same seal, which seals the tool parts in relation to the ambient air pressure thereof, the cavity can both be evacuated via the opening to the vacuum connection and also the evacuated cavity can be sealed in relation to the opening to the vacuum connection as needed and in a cost-effective and simple manner.

In a first embodiment of the control means, it is preferable for an injection facility for introducing a resin system into the evacuated cavity to be able to be activated in the second closed position.

In a second, alternative or additional embodiment of the control means, it is preferable for the cavity of the tool parts to be able to be closed to the desired component thickness of the plastic component already in the second closed position or only in a third closed position; so that advantageously in particular both high-pressure compression RTM methods (HP-CRTM) and also high-pressure injection RTM methods (HP-IRTM) can be performed.

Finally, an embodiment of the control means is preferred according to the invention, using which, during the movement of the tool parts into the second or third closed position, in which additionally at least one second seal seals the tool parts in relation to the ambient air pressure thereof, the vacuum connection remains activated, so that vacuum can still be maintained in the tool via the opening to the vacuum connection.

The object of the present invention is also a method for producing a preferably fiber-reinforced plastic component in at least two tool parts, which can be moved toward one another, of a molding tool, in particular in a molding tool as described above, wherein a cavity can be formed using the tool parts, which corresponds to the desired component thickness of the plastic component to be manufactured; and in particular using a control means as described above.

The method according to the invention for producing a preferably fiber-reinforced plastic component is distinguished in relation to the known method in that the two tool parts, which are already equipped with a fiber preform of the plastic component in particular, are firstly moved into a first closed position, in which at least one first seal seals the tool parts in relation to the ambient air pressure thereof such that the cavity can be evacuated via an opening to a vacuum connection; subsequently the cavity formed by the tool parts is evacuated via the opening to the vacuum connection; subsequently the two tool parts are moved into a second closed position, in which the at least one first seal also seals the evacuated cavity in relation to the opening to the vacuum connection; and subsequently an injection facility for introducing a resin system into the cavity is activated. Due to the advantageous movement of the tool parts into at least two closed positions, the cavity can be evacuated via the opening to the vacuum connection and also the evacuated cavity can be sealed in relation to the opening to the vacuum connection using only one seal, which seals the tool parts in relation to the ambient air pressure thereof, as needed and in a cost-effective and simple manner.

An embodiment of the method is preferred according to the invention in which in addition at least one second seal, which seals the tool parts in relation to the ambient pressure thereof, is arranged between the first and the second tool parts according to plan in relation to the first seal and the opening to the vacuum connection such that vacuum can also still be maintained in the tool via the opening when the tool parts have already been moved into the second closed position for an introduction of the resin system into the evacuated cavity.

To be able to perform in particular both high-pressure compression RTM methods (HP-CRTM) and also high-pressure injection RTM methods (HP-IRTM), finally an alternative or additional embodiment of the method has proven itself, in which the cavity formed using the tool parts corresponds to the desired component thickness of the plastic component to be manufactured already with the movement of the tool parts into the second closed position or only after moving the tool parts into a third closed position.

The object of the present invention is also a facility for performing a method for producing a preferably fiber-reinforced plastic component, in particular a method as described above. The facility according to the invention is distinguished by a molding tool as described above having at least two tool parts which can be moved toward one another into at least one first and one second closed position, using which a cavity can be formed, which corresponds to the desired component thickness of the plastic component to be manufactured; at least one opening, which is implemented in one tool part, to a vacuum connection for evacuating the cavity; an injection facility for introducing a resin system into the evacuated cavity; and a press for moving and fixing the tool parts in the open and closed positions of the molding tool. Finally, the facility according to the invention is distinguished in a refinement by a control means as described above for the purpose of controlling the press for moving and fixing the tool parts in the open and closed positions of the molding tool.

The present invention provides a reliable sealing method in particular for the opening to a vacuum connection for evacuating the cavity. In a preferred embodiment according to the invention, it advantageously ensures, in particular with the aid of a second seal, that vacuum is maintained in the tool also when the tool parts have already been moved into the second closed position for an introduction of the resin system into the evacuated cavity. It is advantageously suitable in particular for all RTM methods.

These and further features and advantages of the invention will be explained in greater detail hereafter on the basis of the exemplary production of a fiber-reinforced plastic component—to which the present invention is not restricted, however—illustrated in the drawings.

In the schematic figures:

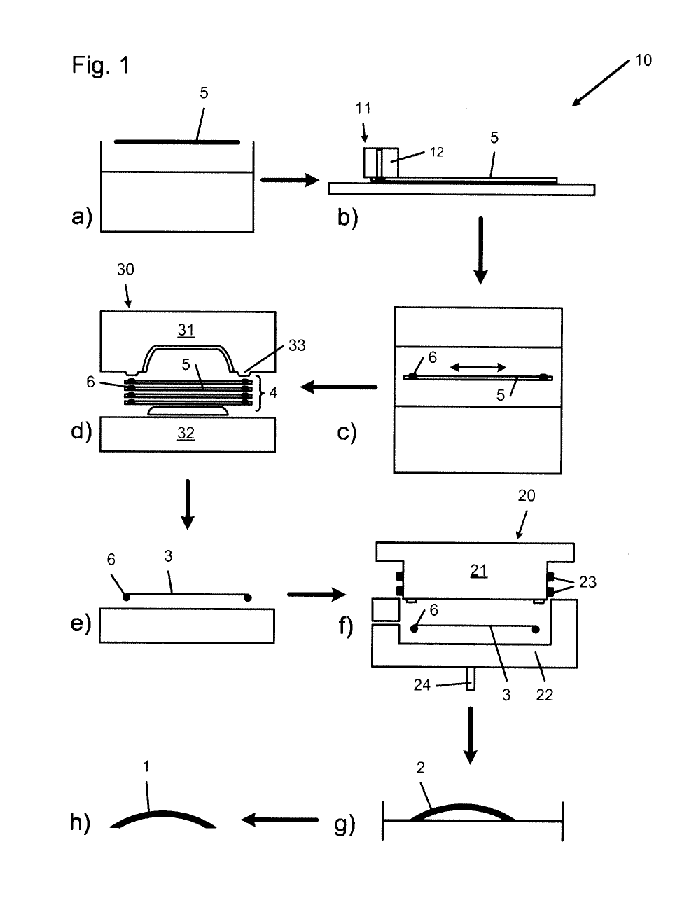

FIG. 1 shows the typical stations a) to h) of a facility for performing a method for producing a fiber-reinforced plastic component and

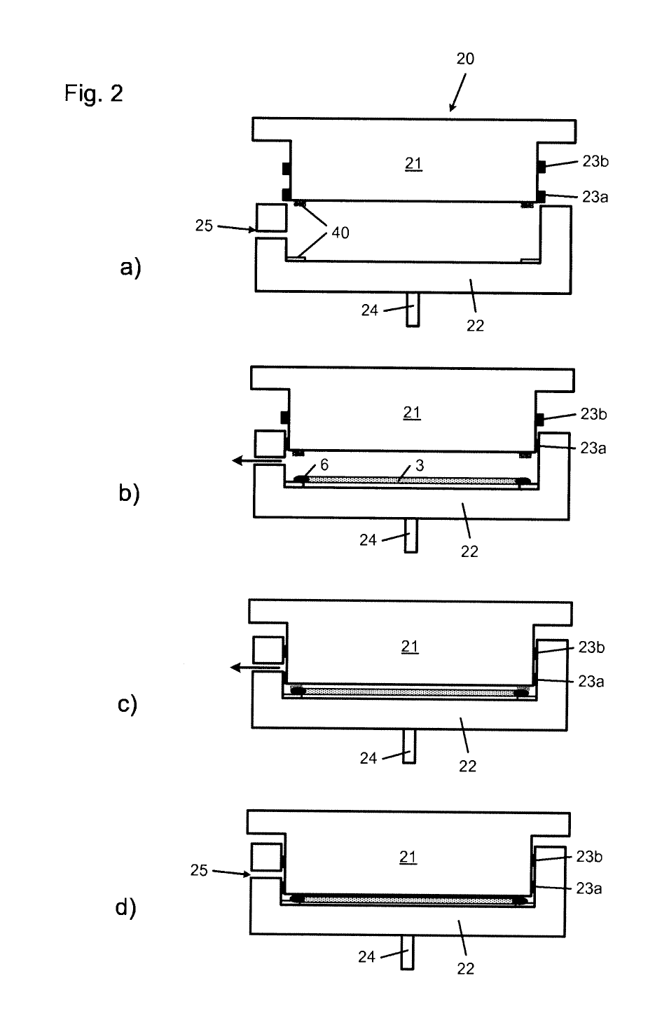

FIG. 2 shows typical process steps a) to d) in an RTM facility, in particular for performing an HP-CRTM method, for producing a fiber-reinforced plastic component.

In the following description of preferred exemplary embodiments, identical reference signs identify identical components. For the introductory description, various reference signs and components are explained beforehand for better comprehension, as they are understood by the invention. A fiber preform 3 is formed in the course of the production from a fiber semifinished product 4, which in turn consists of at least two fiber mats 5 or of comparable fiber woven fabrics and therefore also can be referred to as a fiber mat stack. The fiber preform 3 can have an edge region to assist in the present process, into which a sealing material has been introduced, which, in particular in extremely high-pressure injection methods, assists the sealing of the tool with a further quasi-seal front. The main form 2 of the finished plastic component 1 essentially differs in transfer or processing steps which are still required, which do not have to be explained in greater detail here. A cavity is understood as the hollow shape formed by the tool parts in the partially or completely closed state, which approximately or completely corresponds to the final form of the plastic molded part.

FIG. 1 schematically shows typical stations a) to h) of a facility 10 for performing a method for producing a fiber-reinforced plastic component 1, at least comprising the following method steps: cutting individual fiber mats 5 to size (method step 1.1) in a cutting station (cf. FIG. 1a); stacking—with or without binder—(cf. FIG. 1c) multiple fiber mats 5 to form a fiber semifinished product 4 outside or inside a preform tool 30 comprising at least two tool parts 31, 32 (method step 1.2) of a preform facility (cf. FIG. 1d) or—in particular if preform and main molding tools are implemented integrally (not shown)—within a molding tool 20, comprising at least two tool parts 21, 22, of an RTM facility; performing a preform process to produce a fiber preform 3 (cf. FIG. 1e) of the plastic component 1 (method step 1.3) in the preform tool 30 of a preform facility (cf. FIG. 1d), and performing an RTM process to produce a main form 2 (cf. FIG. 1g) of the plastic component 1 (method step 1.4) in the molding tool 20 of an RTM facility (cf. FIG. 1f).

In the implementation of a fully automatic mass production process in the RTM method, the fact that the seal arranged between tool upper part 21 and tool lower part 22 comes into contact with resin and has to either be cleaned in a time-consuming manner after the cycle or even cyclically replaced, represents one of the large handling requirements, in particular for a resin which is injected under high pressure or over-compacted.

To avoid this, a facility and a method for producing a fiber-reinforced plastic component 1 are claimed in DE 10 2012 110 353.4 of today's date, to which reference is hereby made in its entirety, and which is distinguished in relation to the prior art by application and/or introduction means 11, such as a flathead nozzle 12 in particular (cf. FIG. 1b) for the purpose of application and/or introduction, which is before, simultaneous, and/or after in relation to method steps 1.2 and/or 1.3, of at least partially circumferential material 6, which is suitable for use as a sealant, to individual, multiple, and/or all fiber mats 5 and/or the fiber semifinished product 4 such that, at latest before the performance of the RTM process provided according to method step 1.4, in a complete circumferential edge region 3a of the fiber preform 3, all fiber pores and fiber intermediate spaces therein are closed by the sealant material 6.

Alternatively or additionally thereto, in the implementation of a fully automatic mass production process in the RTM method, the fact that the opening 25 to a vacuum connection, which is arranged between the upper and the lower tool parts 21, 22, for evacuating the cavity comes into contact with resin and must be cleaned in a time-consuming manner after the cycle, also represents one of the large handling requirements.

To avoid this, the present invention provides a sealing method in particular for the opening 25 to a vacuum connection for evacuating the cavity (cf. FIG. 10, which is distinguished in particular in that at least one first seal 23a is arranged between the first and the second tool parts 21, 22 according to plan with respect to the opening 25 to the vacuum connection such that in a first closed position A of the tool parts 21, 22, the cavity can be evacuated via the opening 25 to the vacuum connection and in a second closed position of the tool parts 21, 22, the evacuated cavity is also sealed in relation to the opening 25 to the vacuum connection.

FIG. 2 shows an example of typical process steps a) to d) in an RTM facility, preferably for performing an HP-CRTM method for producing a preferably fiber-reinforced plastic component 1.

FIG. 2a shows the molding tool 20, comprising at least two tool parts 21, 22, of an RTM facility in an open position. In this case, the upper tool part (patrix) 21 and the lower tool part (matrix) 22 are implemented as corresponding to one another such that, in a final closed position, they implement a cavity corresponding to the main form 2 of the plastic component 1, into which a resin system is later injected. To keep the molding tool 20 tightly closed in relation to the surrounding air pressure during the injection of the resin via an injection facility 24, for the infiltration of the fiber preform 3, at least one main seal 23, which contains elastomeric material in particular, is located between tool upper part 21 and tool lower part 22. Depending on the construction of the tool parts 21 and 22, however, two or more so-called seals 23a and 23b can also be provided—as shown in FIG. 2a—which seal a tool part 21 with the other tool part 22 completely in relation to this ambient air pressure, for example, circumferentially. For the evacuation of the cavity required before the infiltration, at least one opening 25 to a vacuum connection is implemented in at least one tool part 21, 22—shown in the tool lower part 22 in FIG. 2a.

FIG. 2b shows the two-part molding tool 20 of an RTM facility from FIG. 2a having a premolded fiber preform 3—but shown as essentially flat in the exemplary embodiment for simplification—laid therein, having sealant material 6 integrated in the edge region thereof, in which, in a complete circumferential edge region of the fiber preform 3, all fiber pores and fiber intermediate spaces therein are thus closed by the sealant material 6. It is recognizable how, in a first closed position, the first partially closed tool parts 21 and 22 are already closable airtight in relation to one another via the lower circumferential seal 23a and the cavity thus formed can be evacuated via the opening 25 to a vacuum connection.

FIG. 2c shows the two-part molding tool 20 of an RTM facility from FIG. 2b in a second, further-closed closed position, in which the opening 25 to the vacuum connection is now additionally sealed by the first (lower) seal 23a in relation to the cavity formed by the tool parts 21, 22 and the tool parts 21, 22 are additionally sealed by a second (upper) seal 23b, so that vacuum can also be maintained in the molding tool 20 via the opening 25 when the tool parts 21, 22 have already been moved into the second closed position for an introduction of the resin system into the evacuated cavity. Depending on the height of the main seal 23, one main seal 23 can be sufficient if it can completely cover the opening 25 in the course of the movement of the tool parts 21, 22 from the first position to the second position. However, it can also be necessary to provide a second seal 23b in this special case. The risk of undesired air enclosures in the plastic component 1 is therefore always avoided, since even in the event of a slight leak of the first seal 23a, the air exclusion can be maintained before and during the RTM process via the second seal 23b. This is also advantageous in particular if an HP-CRTM process is performed in the RTM facility in particular, i.e., in the second closed position, the tool parts 21 and 22 are first closed to a defined gap dimension, to inject resin without noticeable flow resistances above or—as shown—below the outer layer of the fiber preform 3 and to compact it in a final closed position with subsequent closing of the tool parts 21, 22.

FIG. 2d shows the two-part molding tool 20 of an RTM facility from FIG. 2c in a third, final closed position, in which the cavity left by the tool parts 21 and 22 now corresponds to the desired component thickness of the plastic component 1 to be manufactured, so that the previously injected resin is pressed into the pores and intermediate spaces of the fiber preform 3, without passing the integrated seal previously implemented in the fiber preform 3 by means of the sealant material 6 in this case.

Finally, a final form of the plastic component 1 (cf. FIG. 1h) can be obtained by simply trimming the main form 2 (cf. FIG. 1g) of the plastic component 1 while cutting off the sealant material 6.

Depending on the desired specification of the plastic component, it can contain mats made of glass fibers, carbon fibers, ceramic fibers, aramid fibers, boron fibers, steel fibers, natural fibers, nylon fibers, or comparable fibers and/or mixtures thereof and/or also so-called random fiber mats (recycled fiber mats).

The present invention provides a reliable sealing method in particular for the opening 25 to a vacuum connection for evacuating the cavity. In a preferred embodiment according to the invention, it advantageously ensures, in particular with the aid of a second seal 23b, that vacuum is still maintained in the tool 20 even when the tool parts 21, 22 have already been moved into the second closed position for an introduction of the resin system into the evacuated cavity. It is therefore advantageously suitable in particular for so-called high-pressure RTM methods (HP-RTM).

Finally, a fiber preform 3 having integrated seal can advantageously be used, and therefore it can also be ensured for the first time for HP-RTM methods that no resin reaches the main seals 23 or the seals 23a, 23b, which are arranged in the RTM tool between the upper and the lower tool parts 21, 22 of a molding tool 20, so that they are also no longer soiled because of resin and must be cleaned or cyclically replaced in a time-consuming manner.

### LIST OF REFERENCE SIGNS: P1442

1 plastic component
2 main form
3 fiber preform
4 fiber semifinished product
5 fiber mats
6 sealant material
10 facility
11 application and/or introduction means
12 flathead nozzle
20 molding tool
21 tool part
22 tool part
23 main seal
23a seal
23b seal
24 injection facility
25 opening
30 preform tool
31 tool part
32 tool part

1. A molding tool for producing a preferably fiber-reinforced plastic component
having at least two tool parts, which are movable toward one another into at least one first and one second closed position, and using which a cavity can be formed, which corresponds to the desired component thickness of the plastic component to be manufactured;
having at least one opening, implemented in one tool part, to a vacuum connection for evacuating the cavity; and
having at least one seal which seals the tool parts in relation to the ambient air pressure thereof wherein
at least one first seal is arranged according to plan between the first and the second tool part with respect to the opening to the vacuum connection such that
in a first closed position of the tool parts, the cavity can be evacuated via the opening to the vacuum connection, and
in a second closed position of the tool parts, the evacuated cavity is also sealed in relation to the opening to the vacuum connection.

2. The molding tool according to claim 1, wherein at least one first seal is implemented on one tool part and the opening to the vacuum connection is implemented in the other tool part.

3. The molding tool according to claim 1, wherein an opening to the vacuum connection is implemented in a side wall of a tool part outside a region of the cavity defining the component thickness of the plastic component.

4. The molding tool claim 1, wherein at least one tool part is operationally connected to an injection facility for introducing a resin system into the evacuated cavity.

5. The molding tool according to claim 4, wherein an injection facility for introducing the resin system is operationally connected to the tool part in which the opening to the vacuum connection is also implemented.

6. The molding tool according to claim 1, wherein
in addition at least one seal, which seals the tool parts in relation to the ambient air pressure thereof, is arranged according to plan between the first and the second tool part with respect to the first seal and the opening to the vacuum connection such that via the opening, vacuum can also still be maintained in the molding tool when the tool parts have already been moved into the second closed position for an introduction of the resin system into the evacuated cavity.

7. A control unit for moving two tool parts of a molding tool toward one another, in particular according to claim 1, wherein a cavity can be formed using the tool parts which corresponds to the desired component thickness of the preferably fiber-reinforced plastic component to be manufactured and wherein an ability to move the tool parts into at least two closed positions is enabled by means of the control unit, wherein
a first closed position, in which at least one first seal seals the tool parts in relation to the ambient air pressure thereof such that the cavity can be evacuated via an opening to a vacuum connection; and
a second closed position, in which the at least one first seal also seals the evacuated cavity in relation to the opening to the vacuum connection.

8. The control unit according to claim 7, wherein the second closed position, an injection facility can be activated to introduce a resin system into the evacuated cavity.

9. The control unit according to claim 7, wherein a cavity of the tool parts can be closed to the desired component thickness of the plastic component already in the second closed position or only in the third closed position.

10. The control unit according to claim 7, wherein during the movement of the tool parts into the second or third closed position, in which at least one second seal additionally seals the tool parts in relation to the ambient air pressure thereof, the vacuum connection remains activated, so that vacuum can still be maintained in the tool via the opening to the vacuum connection.

11. A method for producing a preferably fiber-reinforced plastic component
in at least two tool parts of a molding tool, which are movable toward one another, wherein a cavity can be formed using the tool parts, which corresponds to the desired component thickness of the plastic component to be manufactured; and
in particular using a control means unit according to claim 7, wherein
11. 1 the two tool parts, which are in particular already equipped with a fiber preform of the plastic component, are firstly moved into a first closed position, in which at least a first seal seals the tool parts in relation to the ambient air pressure thereof such that the cavity can be evacuated via an opening to a vacuum connection;
11. 2 subsequently the cavity formed by the tool parts is evacuated via the opening to the vacuum connection;
11. 3 subsequently the two tool parts are moved into a second closed position, in which the at least one first seal also seals the evacuated cavity in relation to the opening to the vacuum connection; and
11.4 subsequently an injection facility is activated to introduce a resin system into the cavity.

12. The method according to claim 11, wherein between the first and the second tool part, additionally at least one second seal, which seals the tool parts in relation to the ambient air pressure thereof, is arranged according to plan with respect to the first seal and the opening to the vacuum connection such that vacuum can also still be maintained in the tool via the opening when the tool parts have already been moved into the second closed position for an introduction of the resin system into the evacuated cavity.

13. The method according to claim 11, wherein the cavity formed using the tool parts corresponds to the desired component thickness of the plastic component to be manufactured already with movement of the tool parts into the second closed position or only after movement of the tool parts into a third closed position.

14. A facility for performing a method for producing a preferably fiber-reinforced plastic component, in particular according to claim 11, at least comprising
a molding tool having at least two tool parts movable toward one another into at least one first and one second closed position, using which a cavity can be formed, which corresponds to the desired component thickness of the plastic component to be manufactured;
at least one opening, which is implemented in one tool part, to a vacuum connection for evacuating the cavity;
an injection facility for introducing a resin system into the evacuated cavity; and
a press for moving and fixing the tool parts in the open and closed positions of the molding tool.

15. The facility according to claim 14, including a control unit according to claim 7 for controlling the press for moving and fixing the tool parts in the open and closed positions of the molding tool.
